(19) United States
(12) Patent Application Publication
(10) Pub. No.: US 2024/0066514 A1
(43) Pub. Date: Feb. 29, 2024

(54) PROCESSES FOR MAKING AND USING SLURRY CATALYST MIXTURES

(71) Applicant: ExxonMobil Chemical Patents Inc., Baytown, TX (US)

(72) Inventors: Valentin P. MUNOZ, Baytown, TX (US); Ryan W. IMPELMAN, Houston, TX (US); Christian T. LUND, Beaumont, TX (US); Chi-l KUO, Atascocita, TX (US)

(21) Appl. No.: 18/263,794

(22) PCT Filed: Mar. 1, 2022
(86) PCT No.: PCT/US2022/070895

§ 371 Date: Aug. 1, 2023

Related U.S. Application Data
(60) Provisional application No. 63/157,379, filed on Mar. 5, 2021.

(51) Int. Cl. B01J 37/04; C08F 2/34; C08F 4/659; C08F 4/6592; C08F 10/02

(52) U.S. Cl. CPC B01J 37/04; C08F 2/34; C08F 4/65904; C08F 4/65916; C08F 4/65927; C08F 10/02

(57) ABSTRACT

Processes for making and using slurry catalyst mixtures. In some embodiments, the process for making the slurry catalyst mixture can include introducing a mineral oil into a vessel. The mineral oil can be heated to a temperature of about 60° C. to about 80° C. to produce a heated mineral oil. A moisture concentration of the heated mineral oil can be reduced to produce a dried mineral oil. Catalyst particles can be introduced into the dried mineral oil to produce a mixture. The mixture can be agitated for at least 2 hours to remove at least a portion of any gas present within pores of the catalyst particles to produce the slurry catalyst mixture. The slurry catalyst mixture can be free of or include ≤1 wt % of any wax having a melting point, at atmospheric pressure, of ≥25° C., based on a total weight of the slurry catalyst mixture.

### FIELD

This disclosure relates to slurry catalyst mixtures. In particular, this disclosure relates to processes for making and using slurry catalyst mixtures.

### BACKGROUND

Gas-phase polymerization is useful for polymerizing ethylene or ethylene and one or more co-monomers. Polymerization processes in fluidized beds are particularly economical. The catalyst introduced into the polymerization reactor can be in the form of a slurry catalyst mixture that includes a catalyst supported on an inert carrier such as silica and suspended in a diluent. The slurry catalyst mixture is transported to the polymerization facility via slurry catalyst cylinders.

During transport of the slurry catalyst cylinders to the polymerization facility, the catalyst particles settle out of the slurry, which leads to the catalyst particles being non-homogeneously distributed throughout the diluent. As such, to be able to use the slurry catalyst mixture once at the polymerization facility, the slurry catalyst cylinders must be rolled, usually at least a few of hours, before the slurry catalyst mixture can be introduced into the polymerization reactor.

Some references of potential interest in this regard include: U.S. Pat. Nos. 6,908,971; 7,202,313; 7,803,324; 7,906,597; 9,512,245; 10,927,205; and WIPO Publication Nos. WO2020/092584; WO2020/092599; WO2020/092606.

There is a need, therefore, for improved processes for making and using slurry catalyst mixtures. This disclosure satisfies this and other needs.

### SUMMARY

Processes for making and using slurry catalyst mixtures are provided. In some embodiments, the process for making the slurry catalyst mixture can include introducing a mineral oil into a vessel. The mineral oil can be heated to a temperature of about 60° C. to about 80° C. to produce a heated mineral oil. A moisture concentration of the heated mineral oil can be reduced to produce a dried mineral oil. Catalyst particles can be introduced into the dried mineral oil to produce a mixture. The mixture can be agitated for at least 2 hours to remove at least a portion of any gas present within pores of the catalyst particles to produce the slurry catalyst mixture. The slurry catalyst mixture can be free of or include ≤1 wt % of any wax having a melting point, at atmospheric pressure, of ≥25° C., based on a total weight of the slurry catalyst mixture.

In some embodiments, a polymerization process can include introducing a carrier gas, one or more olefins, and a first slurry catalyst mixture into a polymerization reactor. The first slurry catalyst mixture can include a contact product of a first catalyst, a first support, a first activator, a first mineral oil, and a wax having a melting point, at atmospheric pressure, of ≥25° C. The first slurry catalyst mixture can include >1 wt % of the wax, based on a total weight of the first slurry catalyst mixture. The process can also include polymerizing the one or more olefins in the presence of the first catalyst within the polymerization reactor to produce a first polymer product and stopping introduction of the first slurry catalyst mixture into the polymerization reactor. The process can also include introducing a second slurry catalyst mixture into the polymerization reactor. The second slurry catalyst mixture can include a contact product of a second catalyst, a second support, a second activator, and a second mineral oil. The second slurry catalyst mixture can be free of or include ≤1 wt % of any wax having a melting point, at atmospheric pressure, of ≥25° C., based on a total weight of the slurry catalyst mixture. The process can also include polymerizing the one or more olefins in the presence of the second catalyst within the polymerization reactor to produce a second polymer product.

### BRIEF DESCRIPTION OF THE DRAWING

FIG. 1 is a schematic of a gas-phase reactor system, according to one or more embodiments described.

FIG. 2 is a schematic of a nozzle, according to one or more embodiments described.

### DETAILED DESCRIPTION

Various specific embodiments, versions and examples of the invention will now be described, including preferred embodiments and definitions that are adopted herein for purposes of understanding the claimed invention. While the following detailed description gives specific preferred embodiments, those skilled in the art will appreciate that these embodiments are exemplary only, and that the invention may be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

As used herein, the indefinite article “a” or “an” shall mean “at least one” unless specified to the contrary or the context clearly indicates otherwise. Thus, embodiments using “an alpha-olefin” include embodiments where one, two or more alpha-olefins are used, unless specified to the contrary or the context clearly indicates that only one alpha-olefin is used.

Unless otherwise indicated, all numbers indicating quantities in this disclosure are to be understood as being modified by the term “about” in all instances. It should also be understood that the precise numerical values used in the specification and claims constitute specific embodiments.

As used herein, “wt %” means percentage by weight, “vol %” means percentage by volume, “mol %” means percentage by mole, “ppm” means parts per million, and “ppm wt” and “wppm” are used interchangeably and mean parts per million on a weight basis. All concentrations herein, unless otherwise stated, are expressed on the basis of the total amount of the composition in question.

An “olefin” is a linear, branched, or cyclic compound of carbon and hydrogen having at least one double bond. For purposes of this specification and the claims appended thereto, when a polymer or copolymer is referred to as including an olefin, e.g., ethylene and at least one C₃ to C₂₀ α-olefin, the olefin present in such polymer or copolymer is the polymerized form of the olefin. For example, when a copolymer is said to have an “ethylene” content of about 35 wt % to about 55 wt %, it is understood that the repeating unit/mer unit or simply unit in the copolymer is derived from ethylene in the polymerization reaction and the derived units are present at about 35 wt % to about 55 wt %, based on a weight of the copolymer. For the purposes of the present disclosure, ethylene shall be considered an α-olefin.

A “polymer” has two or more of the same or different repeating units/mer units or simply units. A “homopolymer” is a polymer having units that are the same. A “copolymer” is a polymer having two or more units that are different from each other. A “terpolymer” is a polymer having three units that are different from each other. The term “different” as used to refer to units indicates that the units differ from each other by at least one atom or are different isomerically. The definition of copolymer, as used herein, includes terpolymers and the like. Likewise, the definition of polymer, as used herein, includes homopolymers, copolymers, and the like. Furthermore, the terms “polyethylene copolymer”, “ethylene copolymer”, and “ethylene-based polymer” are used interchangeably to refer to a copolymer that includes at least 50 mol % of units derived from ethylene.

Nomenclature of elements and groups thereof used herein are pursuant to the NEW NOTATION published in HAWLEYS CONDENSED CHEMICAL DICTIONARY, Thirteenth Edition, John Wiley & Sons, Inc., (1997) (reproduced there with permission from IUPAC), unless reference is made to the Previous IUPAC form noted with Roman numerals (also appearing in the same), or unless otherwise noted.

As used herein, the term “slurry catalyst mixture” refers to a contact product that includes at least one catalyst compound and a mineral oil, and optionally one or more of an activator, a co-activator, and a support. In a preferred embodiment, the slurry catalyst mixture includes a contact product that includes at least two catalyst compounds and the mineral oil, and optionally one or more of an activator, a co-activator, and a support.

As used herein, the term “catalyst system” refers to a combination of at least one catalyst compound, an optional activator, an optional co-activator, and an optional support material. As such, in some embodiments the catalyst system can include only a single catalyst compound when the optional activator, the optional co-activator, and the optional support material are not present. In other embodiments, the catalyst system can include only two or more catalyst compounds when the optional activator, the optional co-activator, and the optional support material are not present. For the purposes of the present disclosure, when catalyst systems are described as including neutral stable forms of the components, it is well understood by one of ordinary skill in the art, that the ionic form of the component is the form that reacts with the monomers to produce polymers. Catalyst systems, catalysts, and activators of the present disclosure are intended to embrace ionic forms in addition to the neutral forms of the compounds/components.

A metallocene catalyst is an organometallic compound with at least one π-bound cyclopentadienyl moiety (or substituted cyclopentadienyl moiety) and more frequently two π-bound cyclopentadienyl moieties or substituted cyclopentadienyl moieties bonded to a transition metal. In the description herein, the metallocene catalyst may be described as a catalyst precursor, a pre-catalyst compound, metallocene catalyst compound or a transition metal compound, and these terms are used interchangeably. An “anionic ligand” is a negatively charged ligand which donates one or more pairs of electrons to a metal ion. For purposes of the present disclosure, in relation to metallocene catalyst compounds, the term “substituted” means that a hydrogen group has been replaced with a hydrocarbyl group, a heteroatom, or a heteroatom containing group. For example, methyl cyclopentadiene (Cp) is a Cp group substituted with a methyl group.

“Alkoxides” include an oxygen atom bonded to an alkyl group that is a C₁ to C₁₀ hydrocarbyl. The alkyl group may be straight chain, branched, or cyclic. The alkyl group may be saturated or unsaturated. In at least one embodiment, the alkyl group may comprise at least one aromatic group.

“Asymmetric” as used in connection with the instant indenyl compounds means that the substitutions at the 4 positions are different, or the substitutions at the 2 positions are different, or the substitutions at the 4 positions are different and the substitutions at the 2 positions are different.

The properties and performance of polyethylene compositions can be advanced by the combination of: (1) varying one or more reactor conditions such as reactor temperature, hydrogen concentration, comonomer concentration, and so on; and (2) selecting and feeding a dual catalyst system having a first catalyst and second catalyst; the dual catalyst system may advantageously be trimmed as needed with additional first and/or second catalyst. Such catalyst trim processes provide for ready adjustment of polyethylene properties by permitting on-the-fly adjustment of ratios of first and second catalyst in the dual catalyst system fed to the reactor.

In various embodiments in accordance with the present disclosure, the slurry catalyst mixture can include a first catalyst compound that can be a “high molecular weight component” and a second catalyst compound that can be a “low molecular weight component.” In other words, the first catalyst can provide primarily for a high molecular-weight portion of the polymer and the second catalyst can provide primarily for a low molecular weight portion of the polymer (e.g., the first catalyst tends to produce relatively higher-molecular-weight polymer chains; while the second catalyst tends to produce relatively lower-molecular-weight polymer chains). In at least one embodiment, a dual catalyst system can be present in a catalyst pot of a reactor system, and a molar ratio of the first catalyst compound to the second catalyst compound of the dual catalyst system can be from 99:1 to 1:99, such as from 90:10 to 10:90, such as from 85:15 to 50:50, such as from 75:25 to 50:50, such as from 60:40 to 40:60. Consistent with the above note regarding trim catalyst systems, the first catalyst compound and/or the second catalyst compound can be added to a polymerization process as a trim catalyst to adjust the molar ratio of the first catalyst compound to the second catalyst compound. In at least one embodiment, the first catalyst compound and the second catalyst compound are each a metallocene catalyst compound.

### Processes for Making the Slurry Catalyst Mixture

A container or vessel can be used to produce or otherwise make the slurry catalyst mixture. One or more mineral oils can be introduced into the vessel. The mineral oil can be heated within the vessel to a temperature of 50° C., 55° C., 60° C., or 65° C. to 75° C., 80° C., 85° C., or 90° C. (with ranges from any foregoing low end to any foregoing high end also contemplated) to produce a heated mineral oil. A moisture concentration of the heated mineral oil can be reduced to produce a dried mineral oil. For instance, moisture concentration of the heated mineral oil can be reduced by at least one of: (i) passing a first inert gas through the heated mineral oil, (ii) passing a second inert gas through a headspace of the vessel, (iii) subjecting the heated mineral oil to a vacuum, and (iv) adding an aluminum-containing compound to the heated mineral oil. In various embodiments, two or more, three or more, or four or more of the above may be employed in combination; for instance, a combination of (i) and (ii) may be employed per some embodiments; and/or a combination of (iii) and (iv) in particular embodiments.

Regarding (i) and (ii), the first and/or second inert gases can independently be or include, but are not limited to, nitrogen, carbon dioxide, argon, or any mixture thereof. Amounts of first and/or second inert gas (passed through the mineral oil or into the head space of the vessel) can be gauged in terms of volumetric turnovers (where each turnover equals the volume of the vessel), and can range from a low of 5, 10, 15, or 20 volumetric turnovers to 30, 40, 45, 50, 55, or 60 volumetric turnovers (with ranges from any low to any high contemplated). Vessel volume is not particularly limited, but may for instance range from a low of any one of 0.75, 1.15, 1.5, 1.9, or 2.3 m³ to a high of 3, 3.8, 5.7, or 7.6 m³. Regarding (iii), the heated mineral oil can be subjected to a vacuum, i.e., a pressure of <101 kPa-absolute, <75 kPa-absolute, <60 kPa-absolute, or <55 kPa-absolute. Vacuum pressures in various embodiments may range from a low of any one of 0.67, 1, 10, 15, or 20 kPa-absolute to a high of any one of 30, 40, 55, 60, 65, or 80 kPa-absolute, with ranges from any foregoing low end to any foregoing high end contemplated herein. The heated mineral oil can be subjected to the vacuum for at time period of 1 hr, 2, hr, 3 hr, 4 hr, or 5 hr to 6 hr, 8 hr. 10 hr, 12 hr, 24 hr, or longer. Regarding (iv), the aluminum-containing compound can be or can include, but is not limited to, a compound represented by the formula AlR₍₃₋ₐ₎Xₐ, where R is a branched or straight chain alkyl, cycloalkyl, heterocycloalkyl, aryl, or a hydride radical having from 1 to 30 carbon atoms, X is a halogen, and a is 0, 1, or 2. For instance, the aluminum-containing compound can be or can include tri-hexyl-aluminum, triethylaluminum, trimethylaluminum, tri-isobutylaluminum, di-isobutylaluminum bromide, di-isobutylaluminum hydride, methyl aluminoxane, modified methyl aluminoxane, ethylaluminoxane, isobutylaluminoxane, or any mixture thereof. The modified methyl aluminoxane can be produced by the hydrolysis of trimethylaluminum and a higher trialkylaluminum, such as triisobutylaluminum. Modified methyl aluminoxanes are generally more soluble in aliphatic solvents and more stable during storage. There are a variety of well-known processes for preparing aluminoxanes and modified aluminoxanes.

In some embodiments, the moisture concentration of the dried mineral oil can be ≤100 ppmw, ≤85 ppmw, ≤70 ppmw, ≤60 ppmw, ≤55 ppmw, ≤50 ppmw, ≤45 ppmw, ≤40 ppmw, ≤35 ppmw, ≤30 ppmw, ≤25 ppmw, or ≤20 ppmw, as measured according to ASTM D1533-12. In some embodiments, the dried mineral oil can have a density of 0.85 g/cm³, 0.86 g/cm³, or 0.87 g/cm³ to 0.88 g/cm³, 0.89 g/cm³, or 0.9 g/cm³ at 25° C. according to ASTM D4052-18a. In some embodiments, the dried mineral oil can have a kinematic viscosity at 40° C. of 50 cSt, 75 cSt, or 100 cSt to 150 cSt, 200 cSt, 250 cSt, or 300 cSt according to ASTM D341-20e1. In some embodiments, the dried mineral oil can have an average molecular weight of 250 g/mol, 300 g/mol, 350 g/mol, 400 g/mol, 450 g/mol, or 500 g/mol to 550 g/mol, 600 g/mol, 650 g/mol, 700 g/mol, or 750 g/mol according to ASTM D2502-14(2019)e1. In at least one embodiment, the mineral oil can be or can include, but is not limited to HYDROBRITE® 380 PO White Mineral Oil (“HB380”) and/or HYDROBRITE® 1000, available from Sonneborn, LLC.

Once the dried mineral oil has been produced, catalyst particles can be introduced into the dried mineral oil to produce a mixture. The mixture can be mixed, blended, stirred, or otherwise agitated for at least 2 hours to remove at least a portion of any gas that can be present within the pores of the catalyst particles, to produce the slurry catalyst mixture. In some embodiments, the mixture can be agitated for 2 hours, 2.5 hours, 3 hours, 3.5 hours, 4 hours, 4.5 hours, 5 hours, or more to produce the slurry catalyst mixture. In some embodiments, the temperature of the mixture can be maintained at a temperature of 50° C., 55° C., 60° C., or 65° C. to 75° C., 80° C., 85° C., or 90° C. during agitation of the mixture. In other embodiments, the temperature of the mixture can be allowed to cool down. For example, the mixture can be allowed to cool down to a temperature of 45° C., 40° C., 35° C., or 30° C. during agitation of the mixture.

In some embodiments, the vessel can include one or more mixing apparatus that can be configured to mix, blend, stir, or otherwise agitate the mixture within the vessel. In some embodiments, the mixing apparatus can be a rotatable mixing apparatus. Suitable rotatable mixing apparatus can include one or more blades or impellers configured to agitate one or more components of the slurry catalyst mixture within the vessel when rotated. The rotatable mixing apparatus can be rotated at 40 rotations per minute (rpm), 50 rpm, 75 rpm, or 100 rpm to 150 rpm, 175 rpm, 200 rpm, 225 rpm, or 250 rpm. In other embodiments, the mixture can be agitated via ultrasonic waves. In still other embodiments, the mixture can be agitated by moving the vessel, e.g., rolling the vessel or rotating the vessel back and forth about an axis thereof.

The mineral oil may also be agitated during introduction into the vessel; during heating of the mineral oil; during reduction of the moisture concentration in the mineral oil; and/or during introduction of the catalyst particles to the mineral oil.

The mineral oil in the slurry catalyst mixture can also be referred to as a diluent. In some embodiments, in addition to the mineral oil, the slurry catalyst mixture can also include one or more additional diluents. Additional diluents can be or can include, but are not limited to, toluene, ethylbenzene, xylene, pentane, hexane, heptane, octane, other hydrocarbons, or any combination thereof.

In some embodiments, the slurry catalyst mixture can have a solids content of 1 wt %, 5 wt %, 10 wt %, or 15 wt % to 25 wt %, 30 wt %, 35 wt %, or 40 wt %, based on the weight of the slurry catalyst mixture. In other embodiments, the slurry catalyst mixture can have a solids content of at least 5 wt %, at least 10 wt %, at least 12 wt %, or at least 15 wt %. In other embodiments, the slurry catalyst mixture can have a solids content of 40 wt % or less, 35 wt % or less, 30 wt % or less, or 25 wt % or less.

Although wax has heretofore been considered necessary for many slurry catalyst mixtures, e.g., for stability (especially for storage and transport), it is noted that slurry catalyst mixtures of various embodiments herein may advantageously omit the wax. Thus, according to such embodiments, the slurry catalyst mixture can be free of any wax having a melting point, at atmospheric pressure, of ≥25° C., based on a total weight of the slurry catalyst mixture. More generally, the slurry catalyst mixture can include ≤3 wt %, ≤2.5 wt %, ≤2 wt %, ≤1.5 wt %, ≤1 wt %, ≤0.9 wt %, ≤0.8 wt %, ≤0.7 wt %, ≤0.6 wt %, ≤0.5 wt %, ≤0.4 wt %, ≤0.3 wt %, ≤0.2 wt %, or ≤0.1 wt % of any wax having a melting point, at atmospheric pressure, of ≥25° C., based on a total weight of the slurry catalyst mixture. As used herein, the term “wax” includes a petrolatum also known as petroleum jelly or petroleum wax. Petroleum waxes include paraffin waxes and microcrystalline waxes, which include slack wax and scale wax. Commercially available waxes include SONO JELL® paraffin waxes, such as SONO JELL® 4 and SONO JELL® 9, available from Sonneborn, LLC. In at least one embodiment, the wax, if present, can have a density (at 100° C.) of 0.7 g/cm³, 0.73 g/cm³, or 0.75 g/cm³ to 0.87 g/cm³, 0.9 g/cm³, or 0.95 g/cm³. The wax, if present, can have a kinematic viscosity at 100° C. of 5 cSt, 10 cSt, or 15 cSt to 25 cSt, 30 cSt, or 35 cSt. The wax, if present, can have a melting point, at atmospheric pressure, of 25° C., 35° C., or 50° C. to 80° C., 90° C., or 100° C. The wax, if present can have a boiling point of 200° C. or greater, 225° C. or greater, or 250° C. or greater.

It should be understood that the term “wax” also refers to or otherwise includes any wax not considered a petroleum wax, which include animal waxes, vegetable waxes, mineral fossil or earth waxes, ethylenic polymers and polyol ether-esters, chlorinated naphthalenes, and hydrocarbon type waxes. Animal waxes can include beeswax, lanolin, shellac wax, and Chinese insect wax. Vegetable waxes can include carnauba, candelilla, bayberry, and sugarcane. Fossil or earth waxes can include ozocerite, ceresin, and montan. Ethylenic polymers and polyol ether-esters include polyethylene glycols and methoxypolyethylene glycols. The hydrocarbon type waxes include waxes produced via Fischer-Tropsch synthesis.

Once the slurry catalyst mixture has been produced, the slurry catalyst mixture can be transferred from the vessel into a catalyst pot or cat pot configured to introduce the slurry catalyst mixture into a gas phase polymerization reactor. As such, in various embodiments, the vessel can be located on-site at a manufacturing facility that includes a gas phase polymerization reactor. By making the slurry catalyst mixture on-site at the manufacturing facility, the use of slurry catalyst cylinders to transport the slurry catalyst mixture can be avoided because the slurry catalyst mixture, upon preparation, can be introduced into the catalyst pot or “cat pot” from which the slurry catalyst mixture can be introduced into the gas phase polymerization reactor. In some embodiments, by making the slurry catalyst mixture on-site at the manufacturing facility, the slurry catalyst mixture can be introduced into the gas phase polymerization reactor within a time period of 180 minutes, ≤150 minutes, ≤125 minutes, ≤100 minutes, ≤80 minutes, ≤60 minutes, ≤50 minutes, or ≤40 minutes upon initiation of agitation of the mixture. In other embodiments, by making the slurry catalyst mixture on-site at the manufacturing facility, the slurry catalyst mixture can be introduced into the gas phase polymerization reactor within a time period of ≤180 minutes, ≤150 minutes, ≤125 minutes, ≤100 minutes, ≤80 minutes, ≤60 minutes, ≤50 minutes, or ≤40 minutes upon ceasing or stopping agitation of the mixture.

Although, as noted above, wax advantageously may be omitted where storage and/or transport stability are not required for certain catalyst mixtures, it was surprisingly discovered that wax and/or additional diluent in certain catalyst mixtures can aid in the polymerization process in certain cases, e.g., depending on identity(ies) of catalyst compound(s) in the slurry catalyst mixture. Thus, surprisingly, even when one would otherwise think that omitting wax or other diluents is desired (e.g., because there is no need for added storage/transportation stability), it is found that certain catalyst slurries should include wax or other diluents. Thus, processes according to various embodiments may include identifying slurry catalyst mixture(s) for which wax and/or additional diluent is desired and including wax in such slurry catalyst mixture(s) (preferably also while not including wax and/or additional diluent in slurry catalyst mixtures where no processing advantage is obtained by the presence of the wax and/or diluent).

Accordingly, polymerization processes per some embodiments can include, at a first time, introducing a carrier gas, one or more olefins, and a first slurry catalyst mixture into a polymerization reactor. The first slurry catalyst mixture can include a contact product of one or more catalysts selected from a first group of catalysts, a first support, a first activator, a first mineral oil, and a wax having a melting point, at atmospheric pressure, of ≥25° C. The first slurry catalyst mixture can include >1 wt % of the wax, based on a total weight of the first slurry catalyst mixture. The one or more olefins can be polymerized in the presence of the first catalyst within the polymerization reactor to produce a first polymer product.

Then, at a second time after the first time, a second slurry catalyst mixture can be introduced into the polymerization reactor. This can occur, e.g., as part of a grade transition or the like in a polymer production campaign (e.g., first slurry catalyst mixture may be stopped before, during, or soon after introduction of the second slurry catalyst mixture). The second slurry catalyst mixture can include a contact product of one or more catalysts selected from a second group of catalysts, a second support, a second activator, and a second mineral oil. The one or more catalysts selected from the second group of catalysts are preferably different from the one or more catalysts selected from the first group of catalysts; however, the first and second supports, activators, and/or mineral oils can be the same or different. The second slurry catalyst mixture, contrary to the first slurry catalyst mixture, can be free of or include ≤1 wt % of any wax having a melting point, at atmospheric pressure, of ≥25° C., based on a total weight of the slurry catalyst mixture. The second slurry catalyst mixture can in particular be produced according to process described above, entailing removing of moisture from the slurry catalyst mixture. The polymerization process can also include polymerizing the one or more olefins in the presence of the second catalyst within the polymerization reactor to produce a second polymer product. In some embodiments, the carrier gas can be or can include, but is not limited to, nitrogen, argon, ethane, propane, or any mixture thereof. In some embodiments, the one or more olefins can be or can include one more substituted or unsubstituted C₂ to C₄₀ alpha olefins, as further described below.

In particular, it is believed that catalysts in the first group of catalysts and those of the second group of catalysts will preferably have different bulk densities; this aids in identifying which slurry catalyst mixtures may benefit from wax and/or additional diluent, and which will not. For instance, the one or more catalysts in the first group of catalysts can have a bulk density of ≥0.43 g/cm³, ≥0.44 g/cm³, or ≥0.45 g/cm³. On the other hand, the one or more catalysts in the second group of catalysts can have a bulk density of <0.45 g/cm³, <0.44 g/cm³, <0.43 g/cm³, <0.42 g/cm³, <0.41 g/cm³, or <0.40 g/cm³. Put in other words, in various embodiments, the bulk density of the one or more catalyst in the first group of catalysts is greater than the bulk density of the one or more catalysts in the second group of catalysts.

### Catalyst Particles

The catalyst or catalyst compounds can be or can include, but are not limited to, one or more metallocene catalyst compounds. In some embodiments, the catalyst can include at least a first metallocene catalyst compound and a second metallocene catalyst compound, where the first and second metallocene catalyst compounds have different chemical structures from one another. Metallocene catalyst compounds can include catalyst compounds having one or more Cp ligands (cyclopentadienyl and ligands isolobal to cyclopentadienyl) bound to at least one Group 3 to Group 12 metal atom, and one or more leaving group(s) bound to the at least one metal atom.

According to some embodiments, any of the metallocene catalysts as described in Paragraphs [0065]-[0081] of WO 2020/092599, which description is incorporated herein by reference. Also suitable are catalyst systems employing a mix of two metallocene catalysts such as those described in US2020/0071437, and in particular a mix of (1) a bis-cyclopentadienyl hafnocene and (2) a zirconocene, such as an indenyl-cyclopentadienyl zirconocene.

More particularly, the bis-cyclopentadienyl hafnocene may be in accordance with one or more of the metallocene catalyst compounds according to formulas (A1) and/or (A2) as described in US2020/0071437: for instance, those per formula (A1) as described in Paragraphs [0069]-[0086] of US2020/0071437; or those per formula (A2) as described in Paragraphs [0086]-[0101] of US2020/0071437, which descriptions are incorporated herein by reference.

Particular examples of hafnocenes according to formula (A1) include bis(n-propylcyclopentadienyl)hafnium dichloride, bis(n-propylcyclopentadienyl)hafnium dimethyl, (n-propylcyclopentadienyl, pentamethylcyclopentadienyl)hafnium dichloride, (n-propylcyclopentadienyl, pentamethylcyclopentadienyl)hafnium dimethyl, (n-propylcyclopentadienyl, tetramethylcyclopentadienyl)hafnium dichloride, (n-propylcyclopentadienyl, tetramethylcyclopentadienyl)hafnium dimethyl, bis(cyclopentadienyl)hafnium dimethyl, bis(n-butylcyclopentadienvl)hafnium dichloride, bis(n-butylcyclopentadienyl)hafnium dimethyl, and bis(1-methyl-3-n-butylcyclopentadienyl)hafnium dimethyl.

Hafnocene compounds according to (A2) that are particularly useful include one or more of the compounds listed in Paragraph [0101] of US2020/0071437, also incorporated by reference herein, such as (for a relatively brief example): rac/meso Me₂Si(Me₃SiCH₂Cp)₂HfMe₂; racMe₂Si(Me₃SiCH₂Cp)₂HfMe₂; rac/meso Ph₂Si(Me₃SiCH₂Cp)₂HfMe₂; rac/meso (CH₂)₃Si(Me₃SiCH₂Cp)₂HfMe₂; rac/meso (CH₂)₄Si(Me₃SiCH₂Cp)₂HfMe₂; rac/meso (C₆F₅)₂Si(Me₃SiCH₂Cp)₂HfMe₂; rac/meso (CH₂)₃Si(Me₃SiCH₂Cp)₂ZrMe₂; rac/meso Me₂Ge(Me₃SiCH₂Cp)₂HfMe₂; rac/meso Me₂Si(Me₂PhSiCH₂Cp)₂HfMe₂; rac/meso Ph₂Si(Me₂PhSiCH₂Cp)₂HfMe₂; Me₂Si(Me₄Cp)(Me₂PhSiCH₂Cp)HfMe₂; etc.

As noted above, suitable catalyst compounds also or instead may include a zirconocene, such as a zirconocene according to formula (B) as described in Paragraphs [0103]-[0113] of US2020/0071437, which description is also incorporated herein by reference, and in particular suitable zirconocenes may be any one or more of those listed in Paragraph [0112] of US2020/0071437, e.g.: bis(indenyl)zirconium dichloride, bis(indenyl)zirconium dimethyl, bis(tetrahydro-1-indenyl)zirconium dichloride, bis(tetrahydro-1-indenyl)zirconium dimethyl, rac/meso-bis(1-ethylindenyl)zirconium dichloride, rac/meso-bis(1-ethylindenyl)zirconium dimethyl, rac/meso-bis(1-methylindenyl)zirconium dichloride, rac/meso-bis(1-methylindenyl)zirconium dimethyl, rac/meso-bis(1-propylindenyl)zirconium dichloride, rac/meso-bis(1-propylindenyl)zirconium dimethyl, rac/meso-bis(1-butylindenyl)zirconium dichloride, rac/meso-bis(1-butylindenyl)zirconium dimethyl, meso-bis(lethylindenyl) zirconium dichloride, meso-bis(1-ethylindenyl) zirconium dimethyl, (1-methylindenyl)(pentamethyl cyclopentadienyl) zirconium dichloride, (1-methylindenyl)(pentamethyl cyclopentadienyl) zirconium dimethyl, or combinations thereof.

### Slurry Catalyst Mixture Including Activators and Supports

As noted above, the slurry catalyst mixture can include one or more activators and/or supports in addition to one or more catalysts. The term “activator” refers to any compound or combination of compounds, supported or unsupported, which can activate a single site catalyst compound or component, such as by creating a cationic species of the catalyst component. For example, this can include the abstraction of at least one leaving group (the ‘X’ group in the single site catalyst compounds described herein) from the metal center of the single site catalyst compound/component. The activator may also be referred to as a “co-catalyst’. For example, the slurry catalyst mixture can include two or more activators (such as aluminoxane and a modified aluminoxane) and a catalyst compound, or the slurry catalyst mixture can include a supported activator and more than one catalyst compound. In particular embodiments, the slurry catalyst mixture can include at least one support, at least one activator, and at least two catalyst compounds. For example, the slurry can include at least one support, at least one activator, and two different catalyst compounds that can be added separately or in combination to produce the slurry catalyst mixture. In some embodiments, a mixture of a support, e.g., silica, and an activator, e.g., aluminoxane, can be contacted with a catalyst compound, allowed to react, and thereafter the mixture can be contacted with another catalyst compound, for example, in a trim system.

The molar ratio of metal in the activator to metal in the catalyst compound in the slurry catalyst mixture can be 1000:1 to 0.5:1, 300:1 to 1:1, 100:1 to 1:1, or 150:1 to 1:1. The slurry catalyst mixture can include a support material which can be any inert particulate carrier material known in the art, including, but not limited to, silica, fumed silica, alumina, clay, talc or other support materials such as disclosed above. In one embodiment, the slurry can include silica and an activator, such as methyl aluminoxane (“MAO”), modified methyl aluminoxane (“MMAO), as discussed further below. Preferred activators typically include aluminoxane compounds, modified aluminoxane compounds, and ionizing anion precursor compounds that abstract a reactive, σ-bound, metal ligand making the metal compound cationic and providing a charge-balancing non-coordinating or weakly coordinating anion. For instance, suitable activators include any of the aluminoxane activators and/or ionizing/non-coordinating anion activators described in Paragraphs [0118]-[0128] of US2020/0071437, also incorporated herein by reference.

As noted above, one or more organo-aluminum compounds such as one or more alkylaluminum compounds can be used in conjunction with the aluminoxanes. For example, alkylaluminum species that can be used include diethylaluminum ethoxide, diethylaluminum chloride, and/or disobutylaluminum hydride. Examples of trialkylaluminum compounds include, but are not limited to, trimethylaluminum, triethylaluminum (“TEAL), triisobutylaluminum “TiBAl), tri-n-hexylaluminum, tri-n-octylaluminum, tripropylaluminum, tributylaluminum, and the like.

Suitable supports include, but are not limited to, active and inactive materials, synthetic or naturally occurring zeolites, as well as inorganic materials such as clays and/or oxides such as silica, alumina, zirconia, titania, silica-alumina, cerium oxide, magnesium oxide, or combinations thereof. In particular, the support may be silica-alumina, alumina and/or a zeolite, particularly alumina. Silica-alumina may be either naturally occurring or in the form of gelatinous precipitates or gels including mixtures of silica and metal oxides. Suitable supports may include any of the support materials described in Paragraphs [0129]-[0131] of US2020/0071437, which description is also incorporated by reference herein; wherein Al₂O₃, ZrO₂, SiO₂ and combinations thereof are particularly noted.

In some embodiments, at least a portion of the slurry catalyst mixture can be contacted with a solution catalyst mixture to produce or otherwise form a slurry/solution catalyst mixture.

### Solution Catalyst Mixture (the “Trim Solution”)

The solution catalyst mixture can include a solvent and only catalyst compound(s), such as a metallocene, or can also include an activator. In some embodiments, the solution catalyst mixture can be or can include, but is not limited to, a contact product of a solvent/diluent and the first catalyst or the second catalyst. In some embodiments, the slurry/solution catalyst mixture can be introduced into the gas phase polymerization reactor. In at least one embodiment, the catalyst compound(s) in the solution catalyst mixture can be unsupported.

The solution catalyst mixture, if used, can be prepared by dissolving the catalyst compound and optional activators in a liquid solvent. In some embodiments, the liquid solvent can be an alkane, such as a C₅ to C₃₀ alkane, or a C₅ to C₁₀ alkane. Cyclic alkanes such as cyclohexane and aromatic compounds such as toluene can also be used. Mineral oil can be used as a solvent alternatively or in addition to other alkanes such as one or more C₅ to C₃₀ alkanes. The mineral oil in the solution catalyst mixture, if used, can have the same properties as the mineral oil that can be used to make the slurry catalyst mixture described above. The solvent employed should be liquid under the conditions of polymerization and relatively inert. In one embodiment, the solvent utilized in the solution catalyst mixture can be different from the diluent used in the slurry catalyst mixture. In another embodiment, the solvent utilized in the solution catalyst mixture can be the same as the diluent, i.e., the mineral oil(s) and any additional diluents used in the slurry catalyst mixture.

If the solution catalyst mixture includes both the catalyst and an activator, the ratio of metal in the activator to metal in the catalyst in the solution catalyst mixture can be 1000:1 to 0.5:1, 300:1 to 1:1, or 150:1 to 1:1. In various embodiments, the activator and catalyst can be present in the solution catalyst mixture at up to about 90 wt %, at up to about 50 wt %, at up to about 20 wt %, such as at up to about 10 wt %, at up to about 5 wt %, at less than 1 wt %, or between 100 ppm and 1 wt %, based on the weight of the solvent, the activator, and the catalyst. The one or more activators in a solution catalyst mixture, if used, can be the same or different as the one or more activators used in a slurry catalyst mixture.

The solution catalyst mixture can include any one of the catalyst compound(s) of the present disclosure. As the catalyst is dissolved in the solution, a higher solubility can be desirable. Accordingly, the catalyst in the solution catalyst mixture can often include a metallocene, which may have higher solubility than other catalysts. In the polymerization process, described below, any of the above described solution catalyst mixtures can be combined with any of the slurry catalyst mixtures described above. In addition, more than one solution catalyst mixture can be utilized.

### Continuity Additive/Static Control Agent

In gas-phase polyethylene production processes, it can be desirable to use one or more static control agents to help facilitate the regulation of static levels within the reactor. The continuity additive is a chemical composition that, when introduced into the fluidized bed within the reactor, can influence or drive static charge (negative, positive, or to zero) in the fluidized bed. The continuity additive used can depend, at least in part, on the nature of the static charge, and the choice of static control agent can vary depending, at least in part, on the polymer being produced and/or the single site catalyst compounds being used. In some embodiments, the continuity additive or static control agent can be introduced into the reactor in an amount of about 0.05 ppm, about 2 ppm, about 5 ppm, about 10 ppm, or about 20 ppm to about 50 ppm, about 75 ppm, about 100 ppm, about 150 ppm, or about 200 ppm.

In some embodiments, the continuity additive can be or can include aluminum stearate. The continuity additive can be selected for its ability to receive the static charge in the fluidized bed without adversely affecting productivity. Other suitable continuity additives can be or can include, but are not limited to, aluminum distearate, ethoxylated amines, and anti-static compositions such as those provided by Innospec Inc. under the trade name OCTASTAT. For example, OCTASTAT 2000 is a mixture of a polysulfone copolymer, a polymeric polyamine, and oil soluble sulfonic acid. Any of the continuity additives can be used either alone or in combination.

In some embodiments, the continuity additive can include fatty acid amines, amide-hydrocarbon or ethyoxylated-amide compounds such as those described as “surface modifiers” in WO Publication No. 96/11961; carboxylate compounds such as aryl-carboxylates and long chain hydrocarbon carboxylates, and fatty acid-metal complexes; alcohols, ethers, sulfate compounds, metal oxides and other compounds known in the art. Some specific examples of control agents can be or can include, but are not limited to, 1,2-diether organic compounds, magnesium oxide, ARMOSTAT® 310, ATMER® 163, ATMER® AS-990, and other glycerol esters, ethoxylated amines (e.g., N,N-bis(2-hydroxyethyl)octadecylamine), alkyl sulfonates, and alkoxylated fatty acid esters; STADIS 450 and 425, KEROSTAT CE 4009 and KEROSTAT CE 5009. chromium N-oleylanthranilate salts, calcium salts of a Medialan acid and di-tert-butylphenol; an α-olefin-acrylonitrile copolymer and polymeric polyamine, EDENOL® D32, sorbitan-monooleate, glycerol monostearate, methyl toluate, dimethyl maleate, dimethyl fumarate, triethylamine, 3,3-diphenyl-3-(imidazol-1-yl)-propin, and like compounds. In some embodiments, another continuity additive can include a metal carboxylate salt, optionally, with other compounds.

In some embodiments, the continuity additive can include an extracted metal carboxylate salt can be combined with an amine containing agent (e.g., an extracted carboxylate metal salt with any family member belonging to the KEMAMINE® (available from PMC Biogenix, Inc.) or ATMER (available from Croda). For example, the extracted metal carboxylate salt can be combined with antistatic agents such as fatty amines, such as, KEMAMINE® AS 990/2 zinc additive, a blend of ethoxylated stearyl amine and zinc stearate, or KEMAMINE® AS 990/3, a blend of ethoxylated stearyl amine, zinc stearate and octadecyl-3,5-di-tert-butyl-4-hydroxyhydrocinnamate.

Other continuity additives can include ethyleneimine additives such as polyethyleneimines having the following general formula: —(CH₂—CH₂—NH)n-, where n can be from about 10 to about 10,000. The polyethyleneimines can be linear, branched, or hyper branched (e.g., forming dendritic or arborescent polymer structures). The polyethyleneimines can be a homopolymer or copolymer of ethyleneimine or mixtures thereof (referred to as polyethyleneimine(s) hereafter). Although linear polymers represented by the chemical formula —(CH₂—CH₂—NH)n- can be used as the polyethyleneimine, materials having primary, secondary, and tertiary branches can also be used. Commercial polyethyleneimine can be a compound having branches of the ethyleneimine polymer.

### Gas Phase Polymerization Reactor

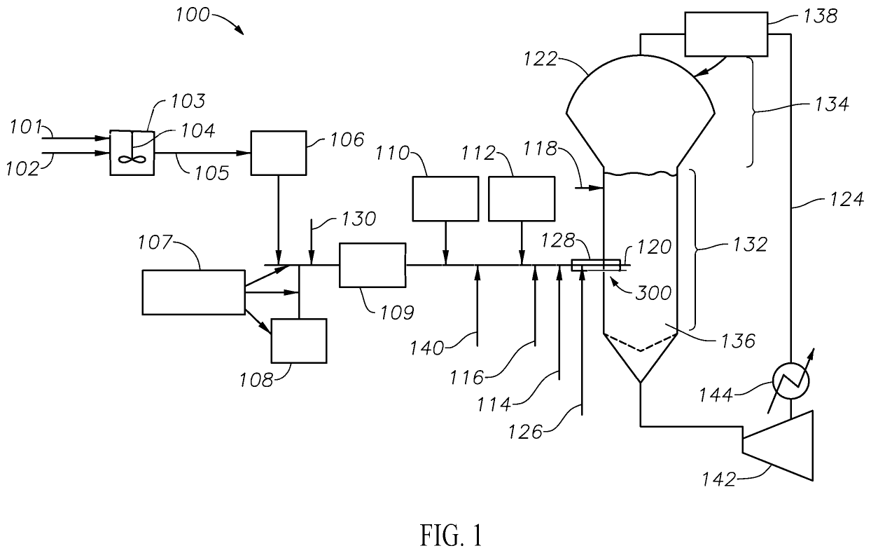

FIG. 1 is a schematic of a gas-phase reactor system 100, showing the addition of at least two catalysts, at least one of which is added as a trim catalyst. The mineral oil via line 101 and first catalyst particles via line 102 and optional additional components can be introduced into a vessel 103 as described above. A mixing apparatus 104 can be disposed within the vessel 103 and can be used to mix or otherwise agitate the components within the vessel 103 as described above to produce the slurry catalyst mixture. The slurry catalyst mixture, once formed or otherwise produced in the vessel 103, can be fed or otherwise introduced via line 105 into a vessel or catalyst pot (cat pot) 106.

The catalyst pot 106 can be an agitated holding tank configured to keep the solids concentration homogenous. In at least one embodiment, the catalyst pot 106 can be maintained at an elevated temperature, such as from 30° C., 40° C., or 43° C. to 45° C., 60° C., or 75° C. Elevated temperature can be obtained by electrically heat tracing the catalyst pot 106 using, for example, a heating blanket. Maintaining the catalyst pot 106 at an elevated temperature can further reduce or eliminate solid residue formation on vessel walls which could otherwise slide off of the walls and cause plugging in downstream delivery lines. In at least one embodiment, catalyst pot 106 can have a volume of 0.75 m³, 1.15 m³, 1.5 m³, 1.9 m³, or 2.3 m³ to 3 m³, 3.8 m³, 5.7 m³, or 7.6 m³.

In at least one embodiment, the catalyst pot 106 can be maintained at pressure of 25 psig or greater, such as from 25 psig to 75 psig, such as from 30 psig to 60 psig, for example about 50 psig. In at least one embodiment, piping 130 and piping 140 of the gas-phase reactor system 100 can be maintained at an elevated temperature, such as from 30° C., 40° C., or 43° C. to 45° C., 60° C., or 75° C. Elevated temperature can be obtained by electrically heat tracing the piping 130 and or the piping 140 using, for example, a heating blanket. Maintaining the piping 130 and/or the piping 140 at an elevated temperature can provide the same or similar benefits as described for an elevated temperature of cat pot 106.

A solution catalyst mixture, prepared by mixing a solvent and at least one second catalyst and/or activator, can be placed in another vessel, such as a trim pot 108. Trim pot 108 can have a volume of 0.38 m³, 0.75 m³, 1.15 m³, 1.5 m³, 1.9 m³, or 2.3 m³ to 3 m³, 3.8 m³, 5.7 m³, or 7.6 m³. The trim pot 108 can be maintained at an elevated temperature, such as from 30° C., 40° C., or 43° C. to 45° C., 60° C., or 75° C. The trim pot 108 can be heated by electrically heat tracing the trim pot 108, for example, via a heating blanket. Maintaining the trim pot 108 at an elevated temperature can provide reduced or eliminated foaming in piping 130 and or piping 140 when the slurry catalyst mixture from cat pot 106 is combined in-line (also referred to herein as “on-line”) with the solution catalyst mixture from trim pot 108.

The slurry catalyst mixture can then be combined in-line with the solution catalyst mixture to form a slurry/solution catalyst mixture or final catalyst composition. A nucleating agent 107, such as silica, alumina, fumed silica or any other particulate matter can be added to the slurry and/or the solution in-line or in the vessels 106 or 108. Similarly, additional activators or catalyst compounds can be added in-line. For example, a second slurry catalyst mixture that includes a different catalyst can be introduced from a second cat pot (which may include wax and mineral oil). The two slurry catalyst mixtures can be used as the catalyst system with or without the addition of a solution catalyst mixture from the trim pot 108.

The slurry catalyst mixture and solution catalyst mixture can be mixed in-line. For example, the solution catalyst mixture and slurry catalyst mixture can be mixed by utilizing a static mixer 109 or an agitating vessel. The mixing of the slurry catalyst mixture and the solution catalyst mixture should be sufficient enough to allow the catalyst compound in the solution catalyst mixture to disperse in the slurry catalyst mixture such that the catalyst component, originally in the solution, migrates to the supported activator originally present in the slurry. The combination can form a uniform dispersion of catalyst compounds on the supported activator forming the catalyst composition. The length of time that the slurry and the solution can be contacted can be 1 minute, 5 minutes, 10 minutes, or 20 minutes to 30 minutes, 40 minutes, 60 minutes, 120 minutes, 180 minutes, or 220 minutes.

In at least one embodiment, static mixer 109 of the gas-phase reactor system 100 can be maintained at an elevated temperature, such as from 30° C., 40° C., or 43° C. to 45° C., 60° C., or 75° C. The elevated temperature of the static mixer 109 can be obtained by electrically heat tracing static mixer 109 using, for example, a heating blanket. Maintaining static mixer 109 at an elevated temperature can provide reduced or eliminated foaming in static mixer 109 and can promote mixing of the slurry catalyst mixture and catalyst solution (as compared to lower temperatures) which reduces run times in the static mixer and for the overall polymerization process.

In another embodiment, an aluminum alkyl, an ethoxylated aluminum alkyl, an aluminoxane, an anti-static agent or a borate activator, such as a C₁ to C₁₅ alkyl aluminum (for example tri-isobutyl aluminum, trimethyl aluminum or the like), a C₁ to C₁₅ ethoxylated alkyl aluminum or methyl aluminoxane, ethyl aluminoxane, isobutylaluminoxane, modified aluminoxane or the like can be added to the mixture of the slurry/solution catalyst mixture in line. The alkyls, antistatic agents, borate activators and/or aluminoxanes can be added from an alkyl vessel 110 directly to the combination of the solution catalyst mixture and the slurry catalyst mixture, or can be added via an additional alkane (such as hexane, heptane, and or octane) carrier stream, for example, from a carrier vessel 112. The additional alkyls, antistatic agents, borate activators and/or aluminoxanes may be present at up to 500 ppm, at 1 to 300 ppm, at 10 ppm to 300 ppm, or at 10 to 100 ppm. A carrier gas 114 such as nitrogen, argon, ethane, propane, and the like, can be added in-line to the mixture of the slurry and the solution. Typically the carrier gas can be added at the rate of about 0.4 kg/hr, 1 kg/hr, 5 kg/hr, or 2 kg/hr to 11 kg/hr, 23 kg/hr, or 45 kg/hr.

In at least one embodiment, a liquid carrier stream can be introduced into the combination of the solution catalyst mixture and the slurry catalyst mixture. The mixture of the solution, the slurry and the liquid carrier stream can pass through a mixer or length of tube for mixing before being contacted with a gaseous carrier stream. Similarly, a comonomer 116, such as hexene, another alpha-olefin, or diolefin, may be added in-line to the mixture of the slurry and the solution.

In one embodiment, a gas stream 126, such as cycle gas, or re-cycle gas 124, monomer, nitrogen, or other materials can be introduced into an injection nozzle 300 that can include a support tube 128 that can at least partially surround an injection tube 120. The slurry/solution catalyst mixture can be passed through the injection tube 120 into the reactor 122. In at least one embodiment, the injection tube may aerosolize the slurry/solution mixture. Any number of suitable tubing sizes and configurations may be used to aerosolize and/or inject the slurry/solution mixture.

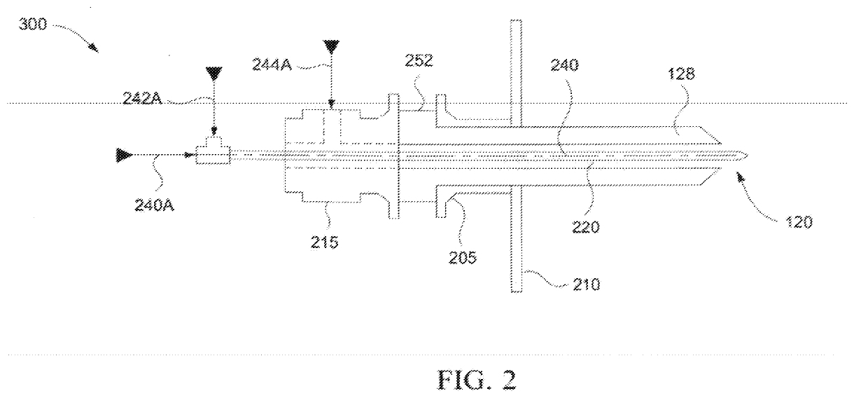

In at least one embodiment, nozzle 300 can be an “effervescent” nozzle. The use of the effervescent nozzle can provide a 3-fold increase or more in nozzle efficiency of a trim process as compared to conventional trim process nozzles. FIG. 2 depicts a schematic of one embodiment of nozzle 300. As shown in FIG. 2, injection nozzle 300 can be in fluid communication with one or more feed lines (three are shown in FIG. 2) 240A, 242A, 244A. Each feed line 240A, 242A, 244A can provide a flow path for one or more monomers, induced condensing agents, carrier fluids, e.g., molecular nitrogen, argon, ethane, propane, and the like, and/or one or more catalyst-containing mixtures, catalysts, and/or catalyst systems to any one or more of the a first conduit 220, a second conduit 240, and a support member or support tube 128. In some embodiments, a feed line 242A can provide the feed provided by piping 140 (shown in FIG. 1), a feed line 240A can provide the carrier fluid in line 126 and/or recycle gas in line 124, and feed line 244A can provide the one or more olefins in line 116 and optionally the one or more induced condensing agents in line 112. Alternatively, feed lines 240A, 242A, and 244A can independently introduce the carrier fluid, the slurry catalyst mixture, and the one or more olefins into the reactor 122.

In some embodiments, feed line or first feed line 240A can be in fluid communication with the second conduit 240. In some embodiments, feed line or second feed line 242A can be in fluid communication with an annulus defined by an outer surface of the second conduit 240 and an inner surface of the first conduit 220. In one or more embodiments, feed line or third feed line 244A can be in fluid communication with an annulus defined by the inner surface of the support member 128 and the outer surface of the first conduit 220.

In some embodiments, the one or more catalyst or catalyst systems can be injected into the first conduit 220 using the second feed line 242A (“catalyst feed line”). The one or more carrier fluids or inert gases can be injected into the second conduit 240 using the first feed line 240A (“purge gas feed line”). The one or more monomers can be injected into the support member 128 using the third feed line 244A (“monomer feed line”). The feed lines 240A, 242A, 244A can be any conduit capable of transporting a fluid therein. Suitable conduits can include tubing, flex hose, and pipe. In some embodiments, a three-way valve 215 can be used to introduce and control the flow of the fluids (e.g., catalyst slurry, purge gas, and monomer) to the injection nozzle 300. Any suitable commercially available three-way valve can be used.

Support member 128 can include a first end having a flanged section 252. The support member 128 can also include a second end that is open to allow a fluid to flow therethrough. In one or more embodiments, support member 128 can be secured to a reactor wall 210. In one or more embodiments, flanged section 252 can be adapted to mate or abut up against a flanged portion 205 of the reactor wall 210 as shown.

In some embodiments, at least a portion of the support tube 128 can have a tapered outer diameter. The second end (“open end”) of support tube 128 can be tapered to reduce the wall thickness at the tip of the support tube 128. Minimizing the area at the tip of support tube 128 can help reduce or prevent fouling. Fouling can be caused due to agglomerate formation of polymer on a nozzle, a concept referred to as “pineappling”. A suitable effervescent nozzle for at least one embodiment of the present disclosure is shown in U.S. Patent Pub. No. 2010/0041841 A1.

As shown in FIG. 2, support member 128 can be a tubular or annular member. Support member 128 can have an inner diameter large enough to surround first conduit 220. The monomer flow, such as through feed line 244A and or through support tube 128, can be from 50 kg/hr to 1,150 kg/hr, such as from 100 kg/hr to 950 kg/hr, such as from 100 kg/hr to 500 kg/hr, such as from 100 kg/hr to 300 kg/hr, such as from 180 kg/hr to 270 kg/hr, such as from 150 kg/hr to 250 kg/hr, for example about 180 kg/hr. These flow rates can be achieved by a support tube, such as support tube 128, having a diameter of from ¼ inch to ¾ inch, for example about ½ inch. A diameter of from ¼ inch to ¾ inch has been discovered to provide reduced flow rates as compared to conventional trim process flow rates (e.g., 1,200 kg/hr), which further provides reduced overall amounts of liquid carrier (such as iC5) and nitrogen used during a polymerization process.

An effervescent nozzle as described herein can further provide control of slurry/solution catalyst mixture droplet size introduced into the reactor as a function of gas velocity and not liquid velocity, which allows a desired droplet size to be achieved by adjusting, for example, the carrier gas flow rate (e.g., 114 of FIG. 1) while allowing a range of carrier fluid (e.g., 112 of FIG. 1) to be utilized during a polymerization process. For example, in at least one embodiment, a ratio of supported catalyst particles per droplet of carrier fluid can be from 1:1 to 10:1, such as 5:1, which can provide reduced overall amounts of liquid carrier (such as iC5) used during a trim polymerization process, as compared to a conventional trim catalyst particle to droplet ratio of 1:1. In at least one embodiment, a carrier gas flow rate can be from 1 kg/hr to 50 kg/hr, such as from 1 kg/hr to 25 kg/hr, such as from 2 kg/hr to 20 kg/hr, such as from 2.5 kg/hr to 15 kg/hr. In at least one embodiment, a carrier fluid flow rate can be from 1 kg/hr to 100 kg/hr, such as from 5 kg/hr to 50 kg/hr, such as from 5 kg/hr to 30 kg/hr, such as from 10 kg/hr to 25 kg/hr, for example about 15 kg/hr.

In at least one embodiment, a plurality of effervescent nozzles (not shown) can be coupled to the reactor. For example, two or more effervescent nozzles can be coupled with the reactor, and the flow rate of slurry from each nozzle can be less than if only one effervescent nozzle was coupled with the reactor. In one embodiment, a flow rate of slurry from two effervescent nozzles can be about 11 kg/hr from each of the nozzles. An additional nozzle (e.g., a third nozzle) can also be coupled with the reactor and can remain inactive (e.g., offline) until one of the first two nozzles becomes inactive. In one embodiment, each effervescent nozzle (e.g., all three nozzles) is active (e.g., online) during a polymerization process. Each component (e.g., catalyst slurry from one cat pot 106) can be fed to the nozzles using a catalyst flow splitter. A suitable catalyst flow splitter is described in U.S. Pat. No. 7,980,264, which is incorporated herein by reference in its entirety.

Returning to FIG. 1, to promote formation of particles in the reactor 122, a nucleating agent 118, such as fumed silica, can be added directly into the reactor 122. Conventional trim polymerization processes include introducing a nucleating agent into the polymerization reactor. However, processes of the present disclosure have provided advantages such that addition of a nucleating agent (such as spray dried fumed silica) to the reactor is merely optional. For embodiments of processes of the present disclosure that do not include a nucleating agent, it has been discovered that a high polymer bulk density (e.g., 0.4 g/cm³ or greater) can be obtained, which is greater than the bulk density of polymers formed by conventional trim processes. Furthermore, when a metallocene catalyst or other similar catalyst is used in the gas phase reactor, oxygen or fluorobenzene can be added to the reactor 122 directly or to the gas stream 126 to control the polymerization rate. Thus, when a metallocene catalyst (which is sensitive to oxygen or fluorobenzene) is used in combination with another catalyst (that is not sensitive to oxygen) in a gas phase reactor, oxygen can be used to modify the metallocene polymerization rate relative to the polymerization rate of the other catalyst. WO 1996/009328 discloses the addition of water or carbon dioxide to gas phase polymerization reactors, for example, for similar purposes.

The example above is not limiting, as additional solution catalyst mixtures and/or slurry catalyst mixtures can be used. For example, a slurry catalyst mixture can be combined with two or more solution catalyst mixtures having the same or different catalyst compounds and or activators. Likewise, the solution catalyst mixture can be combined with two or more slurry catalyst mixtures each having the same or different supports, and the same or different catalyst compounds and or activators. Similarly, two or more slurry catalyst mixtures can be combined with two or more solution catalyst mixtures, for example in-line, where the slurry catalyst mixtures each include the same or different supports and can include the same or different catalyst compounds and or activators and the solution catalyst mixtures can include the same or different catalyst compounds and or activators. For example, the slurry catalyst mixture can contain a supported activator and two different catalyst compounds, and two solution catalyst mixtures, each containing one of the catalysts in the slurry, and each can be independently combined, in-line, with the slurry.

Referring again to FIG. 1, the fluidized bed reactor 122 can include a reaction zone 132 and a velocity reduction zone 134. The reaction zone 132 can include a bed 136 that can include growing polymer particles, formed polymer particles and a minor amount of catalyst particles fluidized by the continuous flow of the gaseous monomer and diluent to remove the heat of polymerization through the reaction zone. Optionally, some of the re-circulated gases 124 can be cooled and compressed to form liquids that can increase the heat removal capacity of the circulating gas stream when readmitted to the reaction zone. A suitable rate of gas flow can be readily determined by experimentation. Make-up of gaseous monomer to the circulating gas stream can be at a rate equal to the rate at which particulate polymer product and monomer associated therewith is withdrawn from the reactor and the composition of the gas passing through the reactor can be adjusted to maintain an essentially steady state gaseous composition within the reaction zone. The gas leaving the reaction zone 132 can be passed to the velocity reduction zone 134 where entrained particles can be removed, for example, by slowing and falling back to the reaction zone 132. If desired, finer entrained particles and dust can be removed in a separation system 138. Such as a cyclone and/or fines filter. The gas 124 can be passed through a heat exchanger 144 where at least a portion of the heat of polymerization can be removed. The gas can then be compressed in a compressor 142 and returned to the reaction zone 132. Additional reactor details and means for operating the reactor 122 are described in, for example, U.S. Pat. Nos. 3,709,853; 4,003,712; 4,011,382; 4,302,566; 4,543,399; 4,882,400; 5,352,749; and 5,541,270; EP 0802202; and Belgian Patent No. 839,380.

The reactor temperature of the fluid bed process can be greater than 30° C., greater than 40° C., greater than 50° C., greater than 90° C., greater than 100° C., greater than 110° C., greater than 120° C., greater than 150° C., or higher. In general, the reactor temperature can be operated at a suitable temperature taking into account the sintering temperature of the polymer product within the reactor. Thus, the upper temperature limit in various embodiments can be the melting temperature of the polyethylene copolymer produced in the reactor. However, higher temperatures can result in narrower molecular weight distributions that can be improved by the addition of a catalyst, or other co-catalysts.

Hydrogen gas can be used in the polymerization process to help control or otherwise adjust the final properties of the polyolefin, such as described in the “Polypropylene Handbook, at pages 76-78 (Hanser Publishers, 1996). Using certain catalyst systems, increasing concentrations (partial pressures) of hydrogen can increase a flow index such as the melt index of the polyethylene polymer. The melt index can thus be influenced by the hydrogen concentration. The amount of hydrogen in the polymerization can be expressed as a mole ratio relative to the total polymerizable monomer, for example, ethylene, or a blend of ethylene and hexene or propylene.

The amount of hydrogen used in the polymerization process can be an amount necessary to achieve the desired melt index of the final polyolefin polymer. For example, the mole ratio of hydrogen to total monomer (H₂:monomer) can be 0.0001 or greater, 0.0005 or greater, or 0.001 or greater. Further, the mole ratio of hydrogen to total monomer (H₂:monomer) can be 10 or less, 5 or less. 3 or less, or 0.10 or less. A range for the mole ratio of hydrogen to monomer can include any combination of any upper mole ratio limit with any lower mole ratio limit described herein. The amount of hydrogen in the reactor at any time can range to up to 5,000 ppm, up to 4,000 ppm in another embodiment, up to 3,000 ppm, or from 50 ppm to 5,000 ppm, or from 50 ppm to 2,000 ppm in another embodiment. The amount of hydrogen in the reactor can be from 1 ppm, 50 ppm, or 100 ppm to 400 ppm, 800 ppm, 1,000 ppm, 1,500 ppm, or 2,000 ppm, based on weight. Further, the ratio of hydrogen to total monomer (H₂:monomer) can be 0.00001:1 to 2:1, 0.005:1 to 1.5:1, or 0.0001:1 to 1:1. The one or more reactor pressures in a gas phase process (either single stage or two or more stages) can vary from 690 kPa, 1,379 kPa, or 1,724 kPa to 2,414 kPa, 2,759 kPa, or 3,448 kPa.

The gas phase reactor can be capable of producing from 10 kg per hour (kg/hr), greater than 455 kg/hr, greater than 4,540 kg/hr, greater than 11,300 kg/hr, greater than 15,900 kg/hr, greater than 22,700 kg/hr, or greater than 29,000 kg/hr to 45,500 kg/hr of polymer.

Also or instead, the polymer product can have a melt index ratio (MIR) ranging from 10 to less than 300, or, in many embodiments, from 20 to 66, such as 25 to 55. The melt index (MI, 12) can be measured in accordance with ASTM D-1238-20.

The polymer product can have a density ranging from 0.89 g/cm³, 0.90 g/cm³, 0.91 g/cm³, or 0.92 g/cm³ to 0.93 g/cm³, 0.95 g/cm³, 0.96 g/cm³, or 0.97 g/cm³. Density can be determined in accordance with ASTM D-792-20. The polymer can have a bulk density, measured in accordance with ASTM D-1895-17 method B, of from 0.25 g/cm³ to 0.5 g/cm³. For example, the bulk density of the polymer can be from 0.30 g/cm³, 0.32 g/cm³, or 0.33 g/cm³ to 0.40 g/cm³, 0.44 g/cm³, or 0.48 g/cm³.

Polymerization process according to various embodiments can include contacting one or more olefin monomers with a slurry catalyst mixture that can include mineral oil and catalyst particles. The one or more olefin monomers can be ethylene and/or propylene and the polymerization process can include heating the one or more olefin monomers and the catalyst system to 70° C. or more to form ethylene polymers or propylene polymers.

Monomers useful herein include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the monomer can include ethylene and one or more optional comonomers selected from propylene or C₄ to C₄₀ olefins, such as C₄ to C₂₀ olefins, such as C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and/or one or more functional groups.

In some embodiments, the C₂ to C₄₀ alpha olefin monomers and optional comonomers include ethylene, propylene, butene, pentene, hexene, heptene, octene, nonene, decene, undecene, dodecene, norbomene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbomene, norbornadiene, and their respective homologs and derivatives, such as norbomene, norbornadiene, and dicyclopentadiene.

In at least one embodiment, one or more dienes can be present in the polymer product at up to 10 wt %, such as at 0.00001 to 1.0 wt %, such as 0.002 to 0.5 wt %, such as 0.003 to 0.2 wt %, based upon the total weight of the composition. In at least one embodiment 500 ppm or less of diene is added to the polymerization, such as 400 ppm or less, such as 300 ppm or less. In other embodiments at least 50 ppm of diene is added to the polymerization, or 100 ppm or more, or 150 ppm or more.

Diene monomers include any hydrocarbon structure, such as C₄ to C₃₀, having at least two unsaturated bonds, where at least two of the unsaturated bonds are readily incorporated into a polymer by either a stereospecific or a non-stereospecific catalyst(s). The diene monomers can be selected from alpha, omega-diene monomers (i.e. di-vinyl monomers). The diolefin monomers are linear di-vinyl monomers, such as those containing from 4 to 30 carbon atoms. Examples of dienes can include, but are not limited to, butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Cyclic dienes include cyclopentadiene, vinylnorbornene, norbomadiene, ethylidene norbornene, divinylbenzene, dicyclopentadiene or higher ring containing dioleins with or without substituents at various ring positions.

In at least one embodiment, the catalyst disclosed herein can be capable of producing ethylene polymers having an Mw from 40,000 g/mol, 70,000 g/mol, 90,000 g/mol, or 100,000 g/mol to 200,000 g/mol, 300,000 g/mol, 600,000 g/mol, 1,000,000 g/mol, or 1,500,000 g/mol. In at least one embodiment, the catalyst disclosed herein can be capable of producing ethylene polymers having a melt index (MI) of 0.6 or greater g/10 min, such as 0.7 or greater g/10 min, such as 0.8 or greater g/10 min, such as 0.9 or greater g/10 min, such as 1.0 or greater g/10 min, such as 1.1 or greater g/10 min, such as 1.2 or greater g/10 min.

“Catalyst productivity” is a measure of how many grams of polymer (P) are produced using a polymerization catalyst comprising W g of catalyst (cat), over a period of time of T hours; and can be expressed by the following formula: P/(T×W) and expressed in units of gPgcat⁻¹hr⁻¹. In at least one embodiment, the productivity of the catalysts disclosed herein can be at least 50 g(polymer)/g(cat)/hour, such as 500 or more g(polymer)/g(cat)/hour, such as 800 or more g(polymer)/g(cat)/hour, such as 5,000 or more g(polymer)/g(cat)/hour, such as 6,000 or more g(polymer)/g(cat)/hour.

### End Uses

The polymers produced by the processes disclosed herein and blends thereof can be useful in forming operations such as film, sheet, and fiber extrusion and co-extrusion as well as blow molding, injection molding, and rotary molding. Films include blown or cast films formed by co-extrusion or by lamination useful as shrink film, cling film, stretch film, sealing films, oriented films, snack packaging, heavy duty bags, grocery sacks, baked and frozen food packaging, medical packaging, industrial liners, membranes, etc., in food-contact and non-food contact applications. Fibers include melt spinning, solution spinning and melt blown fiber operations for use in woven or non-woven form to make filters, diaper fabrics, medical garments, geotextiles, etc. Extruded articles include medical tubing, wire and cable coatings, pipe, geomembranes, and pond liners. Molded articles include single and multi-layered constructions in the form of bottles, tanks, large hollow articles, rigid food containers and toys, etc.

Specifically, any of the foregoing polymers, such as ethylene copolymers or blends thereof, can be used in mono- or multi-layer blown, extruded, and/or shrink films. These films may be formed by any number of well-known extrusion or coextrusion techniques, such as a blown bubble film processing technique, wherein the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented, or biaxially oriented to the same or different extents.

### Blends

The polymers produced herein may be further blended with one or more second polymers and used in film, molded part and other typical applications. In one embodiment, the second polymer can be selected from ethylene homopolymer, ethylene copolymers, and blends thereof. Useful second ethylene copolymers can include one or more comonomers in addition to ethylene and can be a random copolymer, a statistical copolymer, a block copolymer, and/or blends thereof. The process of making the second ethylene polymer is not critical, as it can be made by slurry, solution, gas phase, high pressure or other suitable processes, and by using catalyst systems appropriate for the polymerization of polyethylene, such as Ziegler-Natta-type catalysts, chromium catalysts, metallocene-type catalysts, other appropriate catalyst systems or combinations thereof, or by free-radical polymerization. In at least one embodiment, second ethylene polymers can be made by the catalysts, activators and processes described in U.S. Pat. Nos. 6,342,566; 6,384,142; 5,741,563; PCT publications WO 03/040201; and WO 97/19991. Such catalysts are well known in the art, and are described in, for example, Ziegler Catalysts (Gerhard Fink, Rolf Mülhaupt and Hans H. Brintzinger, eds., Springer-Verlag 1995); Resconi et al.; and I, II Metallocene-based Polyolefins (Wiley & Sons 2000).

### Listing of Embodiments

This disclosure may further include the following non-limiting embodiments.
A1. A process for making a slurry catalyst mixture, comprising: (I) introducing a mineral oil into a vessel; (II) heating the mineral oil to a temperature of about 60° C. to about 80° C. to produce a heated mineral oil; (III) reducing a moisture concentration of the heated mineral oil to produce a dried mineral oil; (IV) introducing catalyst particles into the dried mineral oil to produce a mixture; and (V) agitating the mixture for at least 2 hours to remove at least a portion of any gas present within pores of the catalyst particles to produce the slurry catalyst mixture, wherein the slurry catalyst mixture is free of or comprises ≤1 wt % of any wax having a melting point, at atmospheric pressure, of ≥25° C., based on a total weight of the slurry catalyst mixture.
A2. The process of A1, wherein the mixture is agitated for at least 2 hours to produce the slurry catalyst mixture in step (V).
A3. The process of A1 or A2, wherein the mineral oil, the dried mineral oil, and the mixture are agitated during steps (II)-(IV).
A4. The process of any of A1 to A3, wherein the moisture concentration of the heated mineral oil is reduced by passing a first inert gas through the heated mineral oil.
A5. The process of any of A1 to A4, wherein the moisture concentration of the heated mineral oil is reduced by subjecting the heated mineral oil to a vacuum.
A6. The process of any of A1 to A5, wherein the moisture concentration of the heated mineral oil is reduced by passing a second inert gas through a headspace of the vessel.
A7. The process of any of A1 to A6, wherein the moisture concentration of the heated mineral oil is reduced by adding an aluminum-containing compound to the heated mineral oil.
A8. The process of A7, wherein the aluminum-containing compound is represented by the formula AlR₍₃₋ₐ₎Xₐ, wherein R is a branched or straight chain alkyl, cycloalkyl, heterocycloalkyl, aryl, or a hydride radical having from 1 to 30 carbon atoms, X is a halogen, and a is 0, 1, or 2.
A9. The process of A7, wherein the aluminum-containing compound comprises tri-hexyl-aluminum, triethylaluminum, trimethylaluminum, tri-isobutylaluminum, di-isobutylaluminum bromide, di-isobutylaluminum hydride, or any mixture thereof.
A10. The process of any of A1 to A9, wherein the dried mineral oil has a density of from 0.85 g/cm³ to 0.9 g/cm³ at 25° C. according to ASTM D4052-18a, a kinematic viscosity at 40° C. of from 50 cSt to 300 cSt according to ASTM D341-20e1, and an average molecular weight of from 300 g/mol to 700 g/mol according to ASTM D2502-14(2019)e1.
A11. The process of any of A1 to A10, wherein the mineral oil, the dried mineral oil, and the mixture are agitated during steps (II)-(V) with a rotatable mixing apparatus.
A12. The process of A11, wherein the rotatable mixing apparatus is rotated at about 40 rpm to about 200 rpm during steps (II)-(V).
A13. The process of any of A1 to A12, wherein the slurry catalyst mixture comprises a contact product of a first catalyst, a second catalyst, a support, an activator, and the mineral oil.
A14. The process of A13, wherein the support comprises silica.
A15. The process of A12 or A13, wherein the activator comprises an aluminoxane.
A16. The process of any of A13 to A15, wherein the first catalyst and the second catalyst each comprise a metallocene catalyst.
A17. The process of any of A13 to A16, wherein the first catalyst comprises rac/meso dimethylsilylbis[((trimethylsilyl)methyl)cyclopentadienyl]hafnium dimethyl, and wherein the second catalyst comprises rac/meso bis(1-methylindenyl)zirconium dimethyl.
A18. The process of any of A1 to A17, wherein the slurry catalyst mixture is produced on-site at a manufacturing facility comprising a gas phase polymerization reactor.
A19. The process of A18, wherein at least a portion of the slurry catalyst mixture is introduced into the gas phase polymerization reactor within a time period of ≤180 minutes upon initiation of step (V).
A20. The process of A18, wherein at least a portion of the slurry catalyst mixture is introduced into the gas phase polymerization reactor within a time period of 60 minutes upon a stopping of step (V).
A21. The process of A19 or A20, wherein the at least a portion of the slurry catalyst mixture is contacted with a solution catalyst mixture to form a slurry/solution catalyst mixture, wherein the solution catalyst mixture comprises a contact product of a diluent and the first catalyst or the second catalyst, and wherein the slurry/solution catalyst mixture is introduced into the gas phase polymerization reactor.
A22. The process of A21, wherein the diluent comprises a mineral oil.
A23. The process of any of A1 to A22, wherein the dried mineral oil has a moisture content of ≤50 ppmw, as measured according to ASTM D1533-12
A24. The process of any of A1 to A23, wherein the catalyst particles have a bulk density of <0.45 g/cm³ as measured according to ASTM D1895-69.
A25. The process of any of A1 to A24, wherein the catalyst particles have a bulk density of <0.43 g/cm³ as measured according to ASTM D1895-69, method A.
A26. The process of any of A1 to A25, further comprising introducing one or more diluents comprising toluene, ethylbenzene, xylene, pentane, hexane, heptane, octane, other hydrocarbons, or a mixture thereof into the vessel such that the slurry catalyst mixture comprises the one or more diluents.
B1. A polymerization process, comprising: introducing a carrier gas, one or more olefins, and a first slurry catalyst mixture into a polymerization reactor, wherein the first slurry catalyst mixture comprises a contact product of a first catalyst, a first support, a first activator, a first mineral oil, and a wax having a melting point, at atmospheric pressure, of ≥25° C., wherein the first slurry catalyst mixture comprises >1 wt % of the wax, based on a total weight of the first slurry catalyst mixture; polymerizing the one or more olefins in the presence of the first catalyst within the polymerization reactor to produce a first polymer product; stopping introduction of the first slurry catalyst mixture into the polymerization reactor; introducing a second slurry catalyst mixture into the polymerization reactor, wherein the second slurry catalyst mixture comprises a contact product of a second catalyst, a second support, a second activator, and a second mineral oil, and wherein the second slurry catalyst mixture is free of or comprises ≤1 wt % of any wax having a melting point, at atmospheric pressure, of ≥25° C., based on a total weight of the slurry catalyst mixture; and polymerizing the one or more olefins in the presence of the second catalyst within the polymerization reactor to produce a second polymer product.
B2. The process of B1, wherein the carrier gas comprises molecular nitrogen.
B3. The process of B1 or B2, wherein the one or more olefins comprises ethylene.
B4. The process of any of B1 to B3, wherein the first mineral oil and the second mineral oil each have a density of from 0.85 g/cm³ to 0.9 g/cm³ at 25° C. according to ASTM D4052-18a, a kinematic viscosity at 40° C. of from 50 cSt to 300 cSt according to ASTM D341-20e1, and an average molecular weight of from 300 g/mol to 700 g/mol according to ASTM D2502-14(2019)e1.
B5. The process of any of B1 to B4, wherein the first activator and the second activator each comprise an aluminoxane.
B6. The process of any of B1 to B5, wherein the first support and the second support each comprise silica.
B7. The process of any of B1 to B6, wherein the first catalyst comprises a mixture of two or more metallocene catalysts selected from a first group of metallocene catalysts.
B8. The process of any of B1 to B8, wherein the second catalyst comprises a mixture of two or more metallocene catalysts selected from a second group of metallocene catalysts.
B9. The process of B7 or B8, wherein the two or more metallocene catalysts in the first group of metallocene catalysts each have a bulk density of ≥0.43 g/cm³ as measured according to ASTM D1895-69, method A.
B10. The process of any of B7 to B9, wherein the two or more metallocene catalysts in the second group of metallocene catalysts each have a bulk density of <0.43 g/cm³ as measured according to ASTM D1895-69.
B11. The process of B7 or B8, wherein the two or more metallocene catalysts in the first group of metallocene catalysts each have a bulk density of ≥0.45 g/cm³ as measured according to ASTM D1895-69, method A.
B12. The process of any of B7, B8, or B11, wherein the two or more metallocene catalysts in the second group of metallocene catalysts each have a bulk density of <0.45 g/cm³ as measured according to ASTM D1895-69.
B13. The process of any of B8 to B12, wherein the second group of metallocene catalysts comprises rac/meso dimethylsilylbis[((trimethylsilyl)methyl)cyclopentadienyl]hafnium dimethyl, rac/meso bis(1-methylindenyl)zirconium dimethyl, or a mixture thereof.
B14. The process of any of B1 to B13, wherein the polymerization reactor is a gas phase polymerization reactor.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A process for making a slurry catalyst mixture, comprising:
(I) introducing a mineral oil into a vessel;
(II) heating the mineral oil to a temperature of about 60° C. to about 80° C. to produce a heated mineral oil;
(III) reducing a moisture concentration of the heated mineral oil to produce a dried mineral oil;
(IV) introducing catalyst particles into the dried mineral oil to produce a mixture; and
(V) agitating the mixture for at least 2 hours to remove at least a portion of any gas present within pores of the catalyst particles to produce the slurry catalyst mixture, wherein the slurry catalyst mixture is free of or comprises ≤1 wt % of any wax having a melting point, at atmospheric pressure, of ≥25° C., based on a total weight of the slurry catalyst mixture.

2. (canceled)

3. The process of claim 1, wherein the mineral oil, the dried mineral oil, and the mixture are agitated during steps (II)-(IV).

4. The process of claim 1, wherein the moisture concentration of the heated mineral oil is reduced by at least one of the following:
passing a first inert gas through the heated mineral oil;
passing a second inert gas through a headspace of the vessel;
subjecting the heated mineral oil to a vacuum; and
adding an aluminum-containing compound to the heated mineral oil.

5. The process of claim 1, wherein the dried mineral oil has a density of from 0.85 g/cm³ to 0.9 g/cm³ at 25° C. according to ASTM D4052-18a, a kinematic viscosity at 40° C. of from 50 cSt to 300 cSt according to ASTM D341-20e1, and an average molecular weight of from 300 g/mol to 700 g/mol according to ASTM D2502-14(2019)e1.

6. The process of claim 1, wherein the mineral oil, the dried mineral oil, and the mixture are agitated during steps (II)-(V) with a rotatable mixing apparatus, and wherein the rotatable mixing apparatus is rotated at about 40 rpm to about 200 rpm during steps (II)-(V).

7. The process of claim 1, wherein:
the slurry catalyst mixture comprises a contact product of a first catalyst, a second catalyst, a support, an activator, and the mineral oil,
the support comprises silica,
the activator comprises an aluminoxane, and
the first catalyst and the second catalyst each comprise a metallocene catalyst.

8. The process of claim 7, wherein the first catalyst comprises rac/meso dimethylsilylbis[((trimethylsilyl)methyl)cyclopentadienyl]hafnium dimethyl, and wherein the second catalyst comprises rac/meso bis(1-methylindenyl)zirconium dimethyl.

9. The process of claim 1, wherein the slurry catalyst mixture is produced on-site at a manufacturing facility comprising a gas phase polymerization reactor.

10. The process of claim 9, wherein at least a portion of the slurry catalyst mixture is introduced into the gas phase polymerization reactor within a time period of ≤180 minutes upon initiation of step (V).

11. The process of claim 10, wherein the at least a portion of the slurry catalyst mixture is contacted with a solution catalyst mixture to form a slurry/solution catalyst mixture, wherein the solution catalyst mixture comprises a contact product of a diluent and the first catalyst or the second catalyst, and wherein the slurry/solution catalyst mixture is introduced into the gas phase polymerization reactor.

12. The process of claim 1, wherein the dried mineral oil has a moisture content of ≤50 ppmw, as measured according to ASTM D1533-12

13. A polymerization process, comprising:
at a first time, introducing a carrier gas, one or more olefins, and a first slurry catalyst mixture into a polymerization reactor, wherein the first slurry catalyst mixture comprises a contact product of a first catalyst system, a first support, a first activator, a first mineral oil, and a wax having a melting point, at atmospheric pressure, of ≥25° C., wherein the first slurry catalyst mixture comprises >1 wt % of the wax, based on a total weight of the first slurry catalyst mixture;
polymerizing the one or more olefins in the presence of the first catalyst within the polymerization reactor to produce a first polymer product;
at a second time after the first time, introducing a second slurry catalyst mixture into the polymerization reactor, wherein the second slurry catalyst mixture comprises a contact product of a second catalyst system, a second support, a second activator, and a second mineral oil, and wherein the second slurry catalyst mixture is free of or comprises ≤1 wt % of any wax having a melting point, at atmospheric pressure, of ≥25° C., based on a total weight of the slurry catalyst mixture; and
polymerizing the one or more olefins in the presence of the second catalyst within the polymerization reactor to produce a second polymer product.

14. The process of claim 13, further comprising stopping introduction of the first slurry catalyst mixture before, at, or after the second time.

15. The process of claim 13, wherein the carrier gas comprises molecular nitrogen, and wherein the one or more olefins comprises ethylene.

16. The process of claim 13, wherein the first mineral oil and the second mineral oil each have a density of from 0.85 g/cm³ to 0.9 g/cm³ at 25° C. according to ASTM D4052-18a, a kinematic viscosity at 40° C. of from 50 cSt to 300 cSt according to ASTM D341-20e1, and an average molecular weight of from 300 g/mol to 700 g/mol according to ASTM D2502-14(2019)e1.

17. The process of claim 13, wherein the first catalyst system comprises a mixture of two or more metallocene catalysts selected from a first group of metallocene catalysts.

18. The process of claim 17, wherein the two or more metallocene catalysts in the first group of metallocene catalysts each have a bulk density of ≥0.45 g/cm³ as measured according to ASTM D1895-69, method A.

19. The process of claim 13, wherein the second catalyst system comprises a mixture of two or more metallocene catalysts selected from a second group of metallocene catalysts.

20. The process of claim 19, wherein the two or more metallocene catalysts in the second group of metallocene catalysts each have a bulk density of <0.45 g/cm³ as measured according to ASTM D1895-69.

21. The process of claim 19, wherein the second group of metallocene catalysts comprises rac/meso dimethylsilylbis[((trimethylsilyl)methyl)cyclopentadienyl]hafnium dimethyl, rac/meso bis(1-methylindenyl)zirconium dimethyl, or a mixture thereof.
